(19) United States
(12) Patent Application Publication
(10) Pub. No.: US 2008/0297481 A1
(43) Pub. Date: Dec. 4, 2008

(54) DIRECT ACCESS MOBILE CONTENT SYSTEM

(75) Inventor: Timothy B. Higginson, Highland Park, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Yuvee, Inc., Highland Park, IL (US)

(21) Appl. No.: 12/130,969

(22) Filed: May 30, 2008

Related U.S. Application Data
(60) Provisional application No. 60/940,954, filed on May 30, 2007.
(60) Provisional application No. 61/013,558, filed on Dec. 13, 2007.

(51) Int. Cl. G06F 3/02

(52) U.S. Cl. 345/169

(57) ABSTRACT

A portable wireless device facilitates easy access to sponsored content over a wireless network. The wireless device includes a keypad user interface having a set of dedicated launch keys that have an assigned function to launch programs/modules providing access to sponsored content. The keypad user interface also includes a first set of programmable displays associated with, but separate from, each one of the set of dedicated launch keys. The programmable displays each present a representation of sponsored content invoked in response to a user pressing a corresponding one of the dedicated launch keys. A launch key data structure includes a set of entries corresponding to individual ones of the dedicated launch keys. Each dedicated launch key entry identifies a networked source of sponsored content accessible by selecting one of the dedicated launch keys. An accounting function associates selecting a dedicated launch key with a first compensation parameter.

### CROSS-REFERENCE TO RELATED APPLICATIONS

This application claims priority of Higginson U.S. Provisional Application Ser. No. 60/940,954 filed on May 30, 2007, for “Direct Access Mobile Content System,” and Higginson U.S. Provisional Application Ser. No. 61/013,558 filed on Dec. 13, 2007, for “Direct Access Mobile Content System,” the contents of both provisional applications are incorporated herein by reference in their entirety, including any references contained therein.

This application also incorporates by reference in its entirety the disclosure of Higginson U.S. Pat. No. 6,703,963 for a “Universal Keyboard.” The disclosure of which includes a description of a multi-function, multi-domain level keypad/keyboard within which the physical and functional features described herein are advantageously incorporated.

### AREA OF THE INVENTION

The present invention generally relates to providing networked communications systems with handheld communications devices capable of providing access to sponsored content (e.g., Web pages and executable networked applications and services) over a wireless network using keyboard or other key-based access on a wireless device, such as, for example, a cellular phone.

### BACKGROUND

To date, the primary access devices for the Internet have been PCs and laptops that are used at static locations, such as desks or coffee shops. These computing devices generally have large keyboards, large screens and some form of mouse/cursor control. Increasingly, however, small, handheld devices (such as cell phones) have incorporated Internet access capability, and the networks to which they connect increasingly offer broadband upload and download capacity. Since far more people globally own and use cell phones—as of 2006, approximately forty percent (40%) of the world's population owned a cell phone—than own or use PCs or laptops, and cell phones are becoming multi-mode devices connected to broadband wireless networks that provide Internet access, there is an urgent need to provide easy access on mobile devices for the content and media available on the traditional static-location Web access devices, such as PCs or laptops.

Currently, most standard mobile phones that are capable of accessing the Internet via cellular networks use a single access soft key—frequently the middle button on the phone's directional pad—that accesses the service provider's Web portal. To move from there to other parts of the Internet (such as other web pages, web applications and web content), the user must perform a series of frequently lengthy scrolls and clicks and text entry. For instance, by at least one communications industry measure, it currently takes on average of twenty clicks to download a ringtone.

### SUMMARY OF INVENTION/DISCLOSURE

The aforementioned shortcomings of mobile devices to provide easy access to a broad range of sources of content, media and applications on the Internet is addressed by a portable wireless device facilitating access to sponsored content over a wireless network and methods associated therewith. The wireless device includes a keypad user interface having a set of dedicated launch keys that have an assigned function to launch programs/modules providing access to sponsored content. The keypad user interface also includes a first set of programmable displays associated with, but separate from, each one of the set of dedicated launch keys. The programmable displays each present a representation of sponsored content invoked in response to a user pressing a corresponding one of the dedicated launch keys.

A launch key data structure is also included in the mobile device. The launch key data structure, by way of example a table in a database, includes a set of entries corresponding to individual ones of the dedicated launch keys. Each dedicated launch key entry in the data structure (e.g., table) includes at least an identification of a networked source of sponsored content accessible by selecting one of the dedicated launch keys on the keypad user interface. A first accounting function associates selection of one of the dedicated launch keys with a first compensation parameter.

Thus, in addition to providing an arrangement for automatically launching a Web page or application via a single key press on a mobile device, the disclosed system and methods provide a mechanism for charging content sponsors (e.g., a business associated with the Web URL or Web application to which a key is dedicated) on a monthly (or other time period) or click-through basis. The charge may be performed and received by the company providing telecommunications services to the device, thereby enabling that company to receive revenue independent of the charging the subscriber fees for voice or data services and, also potentially allowing subsidization of the device cost through revenue received from content sponsors over the duration of use of the device by a subscriber.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic network diagram showing an exemplary cellular phone and Internet environment suitable for carrying out an embodiment of the present invention;

FIG. 2 is a schematic drawing depicting various components (client, network, servers) for carrying out an illustrative embodiment;

FIG. 3 is an illustrative cellular phone user interface including a main graphical display and a keypad including individual displays that are configurable via software to carry out a variety of functions and potentially provide a variety of input values for each of the functions;

FIGS. 4 and 5 are illustrative keypad interface views with a representation of additional key displays (presently not displayed) that are provided by scrolling or hierarchical arrangement of keys on the right column of the cell phone keypad interface;

FIGS. 6a, 6b, 6c and 6d summarize elements of an illustrative database table structure/schema for providing functionally related information defining the operation of a cellular phone or other wireless device incorporating the dedicated launch key functionality described herein;

FIG. 7 is a flowchart depicting an exemplary set of steps for programming the database to support particular launch key (for identified Internet sites);

FIG. 8 is a flowchart depicting an exemplary set of steps for carrying out billing/accounting associated with launch keys; and

FIG. 9 is a flowchart depicting an exemplary set of steps for accessing (launching) a Web site in response to a user selecting a dedicated launch key on a cellular phone keypad interface depicted, by way of example, in FIG. 3.

### DETAILED DESCRIPTION OF THE DRAWINGS

Attention is directed to the set of figures. The figures illustratively depict a mobile device interface for Internet access according to a set of dedicated launch keys, associated accounting and billing systems and network access that provides a set of dedicated physical keys on a mobile device. The interface facilitates launching and accessing Web-based applications and URLs and performing associated accounting functions.

The diagrams and images generally show a user interface containing a set of hybrid display/physical keys dedicated to launching features and applications of a mobile device, including, importantly, Web-based applications and URLs. The dedicated launch keys have a scrolling ability such that there are as many in this list of individual keys as the database and memory in the device permit. One or more of each of the keys in this list is assigned a single, specific Web-based application or URL by the software running the device. This assignment is done permanently in advance of purchase by the network operator or the handset manufacturer, or, alternatively, is done on a download basis at any time by the network operator, and, alternatively, the software running the device may give the user the option of changing the assignment of some or all of the keys.

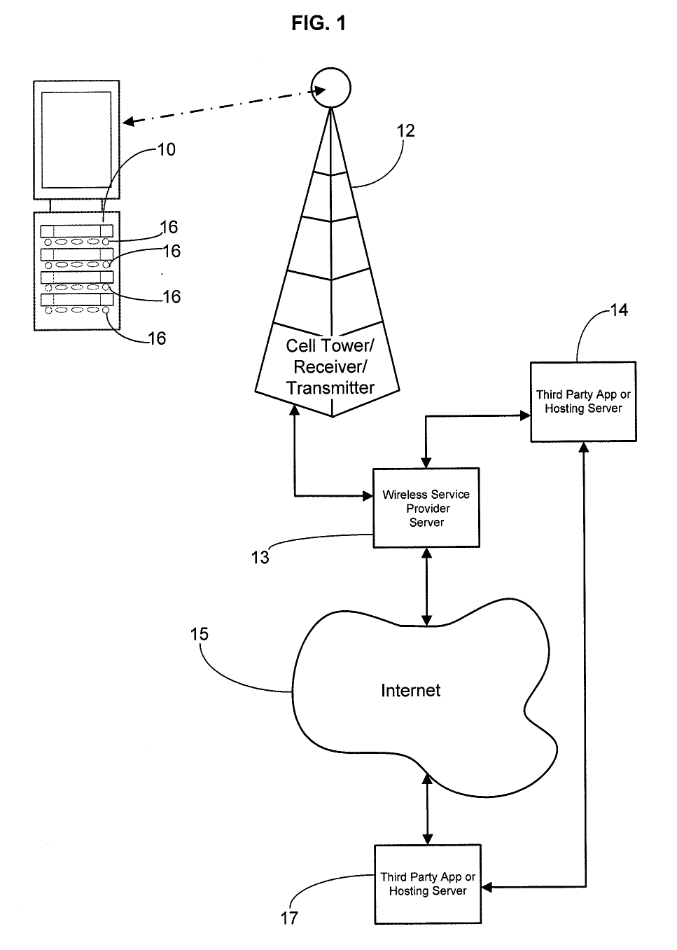

FIG. 1 illustratively depicts a schematic view of an exemplary environment wherein a device 10 containing a separate and distinct interface for displaying and launching applications and URLs identified in an area 11 of the device 10 while the device 10 is communicatively connected to a wireless network via communication with a wireless (e.g., cellular) reception point 12 and wherein a signal to launch an application or URL is sent from the device 10 when a user selects an application or URL by pressing a key of a set of keys 16 within the area 11, and wherein that signal is directed initially to a service provider server 13. The service provider server 13, in turn, issues directions to provide direct access to the application or URL, and that signal is also captured by software on a server system 14 indicating a “click”/command to launch the user-selected application or URL together with an identifier of the mobile device (and, potentially, time and location of the access and other information).

Further, in the system depicted in FIG. 1, a hand-off to the application or URL provider's servers 17 of information about the user of the device permits the application or URL provider to personalize the launched application or URL with the user's specific profile and/or preferences to the extent that the application or URL provider's application or URL has the capability of doing so. Software on the server system 14 that logs the click by the user of one of the set of keys 16 on the device 10 also can be set up to directly access the application or URL provider's servers 17 in order to bill (or automatically charge/deduct) the application or URL provider for the cost of the click-through. Alternatively, the network operator sets up an advance billing system for estimated click-throughs and/or a set monthly fee for an application or URL that has a dedicated key. Each of the servers 13, 14 and 17 and the software resident thereon is operated, for example, by third party service providers.

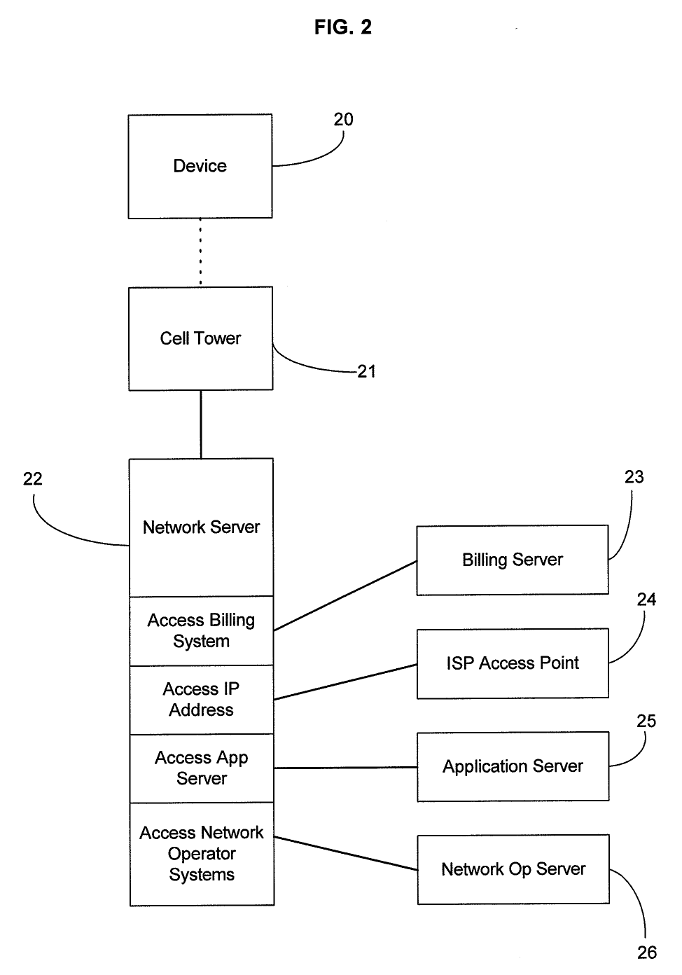

FIG. 2 displays a schematic view of functional components of a system wherein a mobile device 20 accesses a network server 22 that routes application launch codes sent by the device 20's operating system when a direct access key is pressed by a user over the wireless service provider's network including, by way of example, a cell tower 21. In this exemplary instance, the server 22 carries out the following operations:
routing billing/accounting queries to a billing/accounting server 23 and returning the results of the query to the mobile device;
a routing Internet access (with IP address) requests to an Internet access point 24 connected to the service provider's network;
routing non-Internet client/server application run requests to the application server 25 identified by the request; and
routing requests to access the network operator's applications to the applicable server 26.
   The server 22 manages/maintains applicable communications connections and routes the data from the applicable servers to the device 20 in both directions as requested by the device OS and the software resident on the applicable servers.

The remote application's communication with the device OS can launch a URL or remote application, while leaving all the keys of the device keypad in standard telephone numeric mode or setting them to text entry mode (except the direct launch keys 16).

Alternatively, the application's communication can re-set all the keys (as stated with the exception of the direct launch keys 11) to a general set of application-specific modes, or, based on an identification of the owner information of the device 20 with a user identification in the remote application's database(s), to a user-specific set of application modes. For instance, if a mobile phone's owner identification information is passed to a remote application (either directly from the phone or from the phone's service provider's databases) consisting of a web-based social networking site, the networking site's server can match this data to its user database information, and, if it finds a match, the social networking site's server can download to the device a set of modes for the physical key/dynamic display keypad interface that are personalized to the specific individual based on the individual's preferences or on the individual's user patterns of the website, either on a standard basis or on a mobile usage basis, thereby personalizing the mobile device's keypad for the user to optimize the user's experience of the social website (and without the need for any user interface information such as menus appearing on the web page view displayed on the upper screen of the mobile phone, such as the user's personal page(s), and without the need for the user to log into the website via the website's home page, and without the necessity for cookies resident on the mobile device).

The same system generally applies to mobile gaming whereby a mobile game remote server places game graphics on an upper screen of the mobile device 20, and optimizes the keypad by re-setting the keys (except for the direct launch keys 16) on the keypad of the mobile device 20 with game commands. Similarly, web-based applications, such as word processing, photography editing, presentation development and spreadsheet programs, when launched by a direct access key and remotely accessed via the network, can re-set the mobile device's entire keypad (with the exception of the direct launch keys 16) based on parameters set by the user or by the remote application to make the user's experience easy and more compelling for the full set of features offered by the remote application.

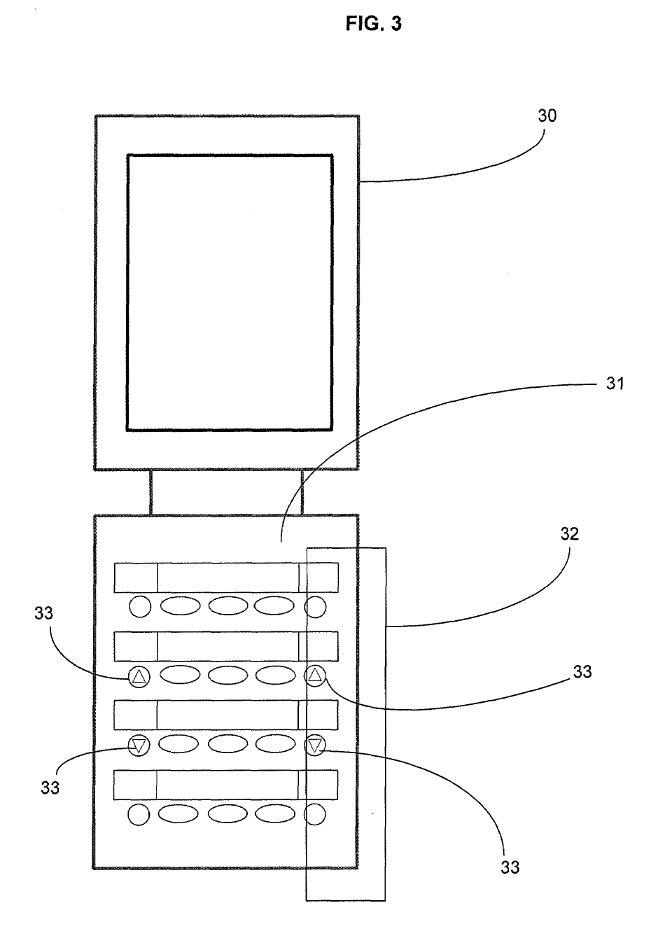

FIG. 3 displays a top view of a device 30 with an array of physical keys and integrated electronic displays 31 with a separate interface set of keys and displays 32 that are dedicated to displaying and launching applications and URLs. In this instance, the array relates to the interface described in Higginson U.S. Pat. No. 6,703,963, the contents of which are incorporated herein by reference in their entirety, including any references therein.

A set of two keys 33 have an integral, uni-directional press-to-scroll functionality indicated by the grey up and down arrows. By pressing and holding these keys, the user scrolls through the list of all URLs, applications and features on or available through the device that have been assigned to direct launch keys 32, in order. The scrolling functionality can also be done using physically separate scroll keys, such as scroll wheels, toggle keys or directional pads. If the keypad technology is implemented using a touchscreen or control surface, the scrolling can be done using virtual keys or other touch control technology. The scrolling enables a virtually infinite list of direct launch keys, listed and scrolling in an order determined by the software and data structures for the keypad interface.

The keypad interface software can implement rules that are also, in whole or in part or expanded upon, distributed to developers as part of software developer kits that enable third party application developers to enhance or optimize their applications consistent with the underlying operational paradigm of the interface. For instance, a rule could be that the top right hand key and its associated display are locked by the software for most or all contexts to switch the device into its basic telephone mode. The scroll functionality would only apply to the dedicated launch keys below the top right key. This gives the user a “home base” and an easy way to put the phone back into its basic telephone mode that no software developer has the right (under the SDK) or the ability (under the core interface software) to override. Similar rules can be defined to build out a set of good programming practices for any third party developer of applications that will run on a device implemented with this system.

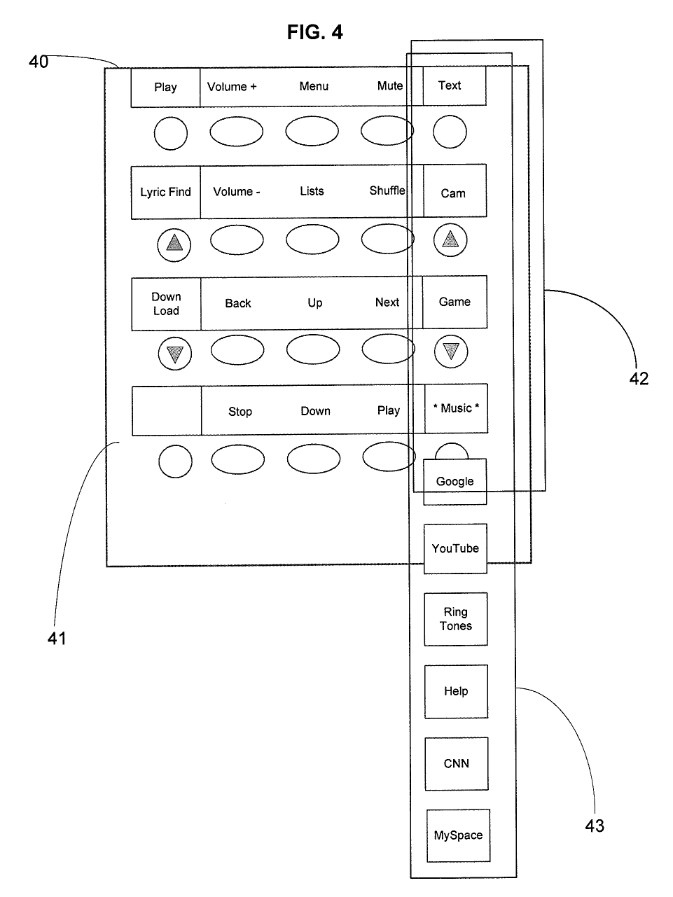

FIG. 4 displays a top view of a device 40 with an array of physical keys and integrated displays 41 with a separate interface set of keys and displays 42 that are dedicated to displaying and launching applications and URLs wherein the scrollable list of applications and URLs 43 is illustratively depicted extending down from the four physical keys. While in fact only 4 direct launch choices are depicted in the keys and displays 42 at any point in time, this demonstrates the ability of this system to assign as many single applications or URLs to each of the direct launch keys in this interface associated with the keys and displays 42 as are necessary or desirable on the mobile device and its associated network services and access.

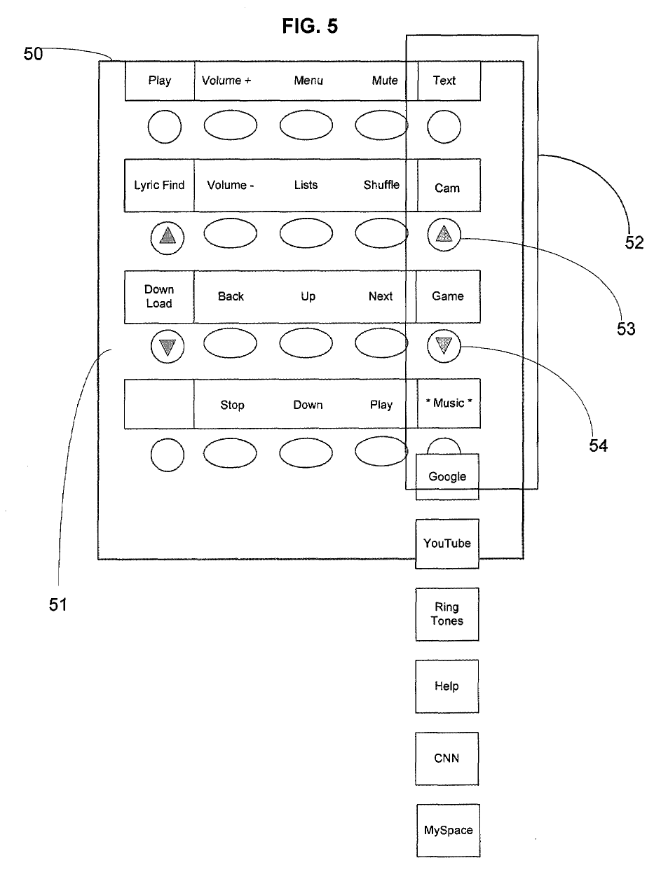

FIG. 5 displays a top view of a device 50 with an array of physical keys and integrated displays 51 with a separate interface set of keys and displays 52 that are dedicated to displaying and launching applications and URLs wherein the scroll up and down functionality is integrated into the same interface and activated by pressing and holding either of a scroll up key 53 or a scroll down key 54. Alternatively, a scroll wheel or scroll up/down toggle key or other separate control surface can be used to scroll up or down the list of applications and URLs appearing in the displays of this separate interface of keys and displays 52. Also, alternatively, there can be less than or more than 4 of the physical keys and associated displays in this separate keys and displays 52 associated with the direct launch capability described herein.

Of course, more or fewer than the number of physical keys shown in the figures for the keypad interface can be implemented. Four keys making up the left and right columns, with the right being the default column for the dedicated launch keys is a preferred implementation for a number of reasons, including, for instance, ease of ergonomic use, a sufficient number of scrolling keys (plus a top key locked to telephone mode, as described above), and optimal text entry mode. Keypad software can provide a user with the ability to change a left/right hand setting, automatically switching the keypad's dedicated launch key column from the right hand side to the left hand side. Twelve keys in the middle is also preferred because, for instance, of its familiarity to most people as the number of keys on standard telephone keypads and calculator keypads.

Further, the entire keypad can be implemented virtually on a touchscreen or control surface, with software creating “active” touch-sensitive areas and allocating virtual display areas for the displays above or on the keys. The implementation shown in certain of the figures is a hybrid of physical keys and integrated dynamic displays, which provides the benefit of tactile ease, familiarity, muscle memory of physical keys and ease of use for visually disabled people, combined with the benefits of displays that change according to the mode the user has selected.

As an alternative, a physical key in the dedicated launch key column can be allocated the role of an aggregator for a category or type of application or URL. When such an aggregator key is pressed, the middle twelve keys display a set of applications or URLs that fit that category. For instance, an aggregator key could be titled “WWW News” and the middle twelve keys when that aggregator key is selected could display one or more of www.cnn.com, www.nytimes.com, www.wsj.com, and www.bbb.org, etc. These can be pre-set, set by the user or set remotely. A click on one of these middle twelve keys performs a direct, one-click launch of that URL or application. The left hand column keys provide access to subsequent sets of launch keys within the same aggregation category. A click on one of the middle twelve keys configured as aggregated dedicated launch keys could result in a click through fee.

Aggregation keys can be determined according to a number of factors, including, for instance, subject matter of URL (e.g., news websites, video websites, search websites, social network websites, etc.), a company with multiple offerings by application or URL (e.g., Google with Google search, Google apps, etc; or Microsoft with Word, Excel, PowerPoint, Visio, etc.), subject matter of application (e.g., mobile gaming or ringtone websites), or user favorites (potentially analogous to play lists or “most-played” on MP3 players).

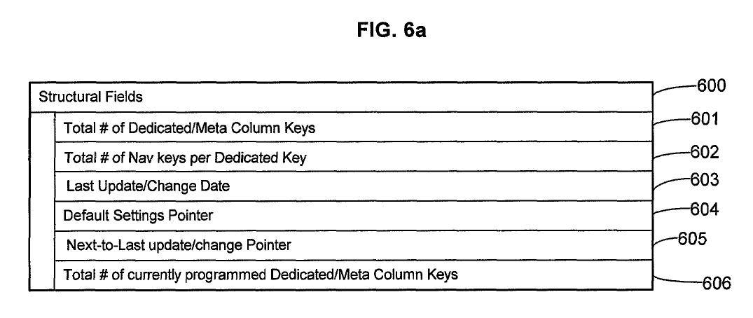

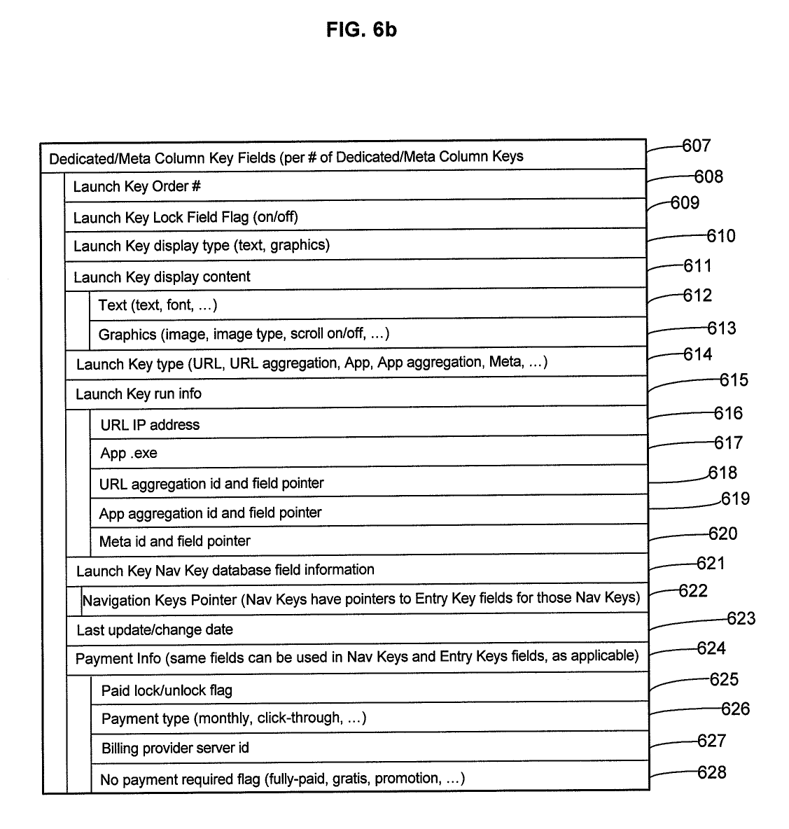

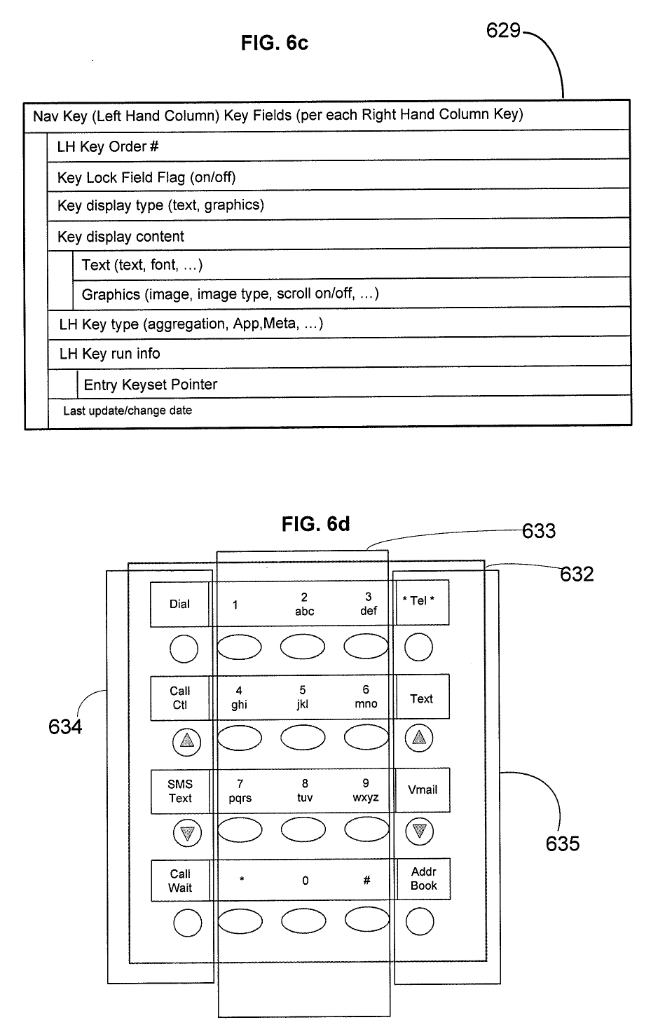

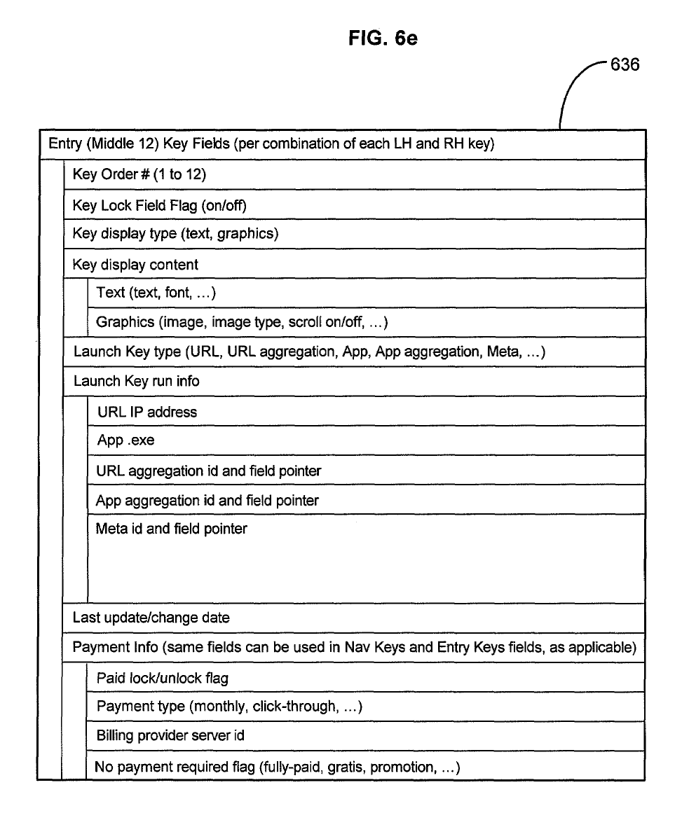

FIGS. 6a, 6b, 6c, 6d and 6e summarize a set of fields generally defining an exemplary database schema for supporting dedicated launch keys that the device's OS, via the device's internal keypad software and remote applications, accesses to operate the keypad's features. A set of Structural Fields 600 depicted in FIG. 6a support a set of data elements describing a high-level status/configuration of a direct access content feature/aspect of a mobile device. A set of Direct Access Key Definition fields 607 depicted in FIG. 6b includes a (per-dedicated launch key) set of fields and database structures that includes, for instance, a corresponding URL or IP address for a dedicated key that launches a website, and that includes network billing/accounting server information, payment information and related information.

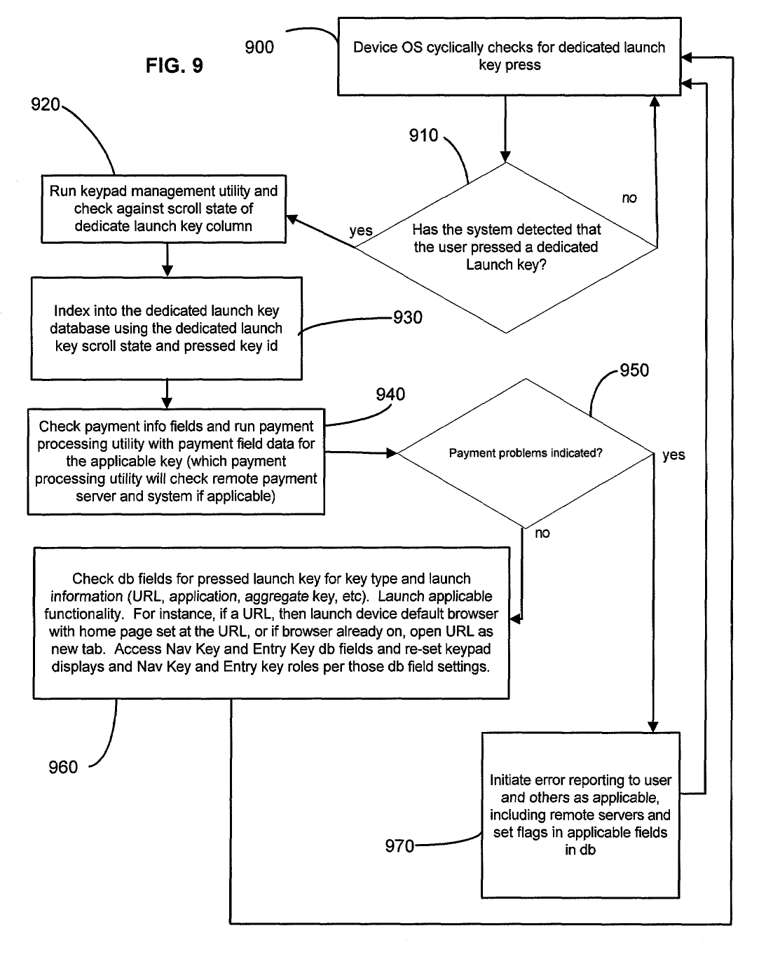

The Structural Fields 600 of FIG. 6a includes a set of table entries for a database that is accessed by keypad management software 920 (described herein below with reference to FIG. 9) running on the device 20, 30 (described herein above respectively with reference to FIGS. 2 and 3). These fields include a total number of keys field 601 for which the database can hold information for the scrollable right hand column of keys 10 (described herein above with reference to FIG. 1), and a total number of keys field 602 for which the database can hold information for the scrollable left hand column of keys, although the database can also be dynamically structured. The middle set of entry keys is always twelve for any single determining combination of a right hand column key and a left hand column key. The fields in the exemplary database (including one or more tables) also include a last update/change date field 603 identifying a latest update of the database. Similarly, the database also includes a next-to-last update/change pointer field 605. The fields include a default settings pointer field 604 containing a set of default parameter settings in case the device's direct access launch key configuration needs to be re-set to its default settings, which can be a restore point or an original set of database information. The fields of the exemplary database also include, for instance, a total number of programmed keys field 606 identifying the number of right hand column soft/virtual keys for which the database holds actual data. The value in keys field 606 relates to the number of direct access keys defined—not the number of physical keys on the right hand side of the keypad of the mobile device.

The core role of the Structural Fields 600 is to set high-level parameters of a set of direct access key definitions stored, on a per direct access key basis, in the form of Direct Access Key Definition fields 607 that are used by the keypad management software 920 (depicted herein below with reference to FIG. 9) to populate the displays and the direct access functionality when keys in the hybrid display/physical key array 31 (depicted herein above with reference to FIG. 3) are pressed by the user.

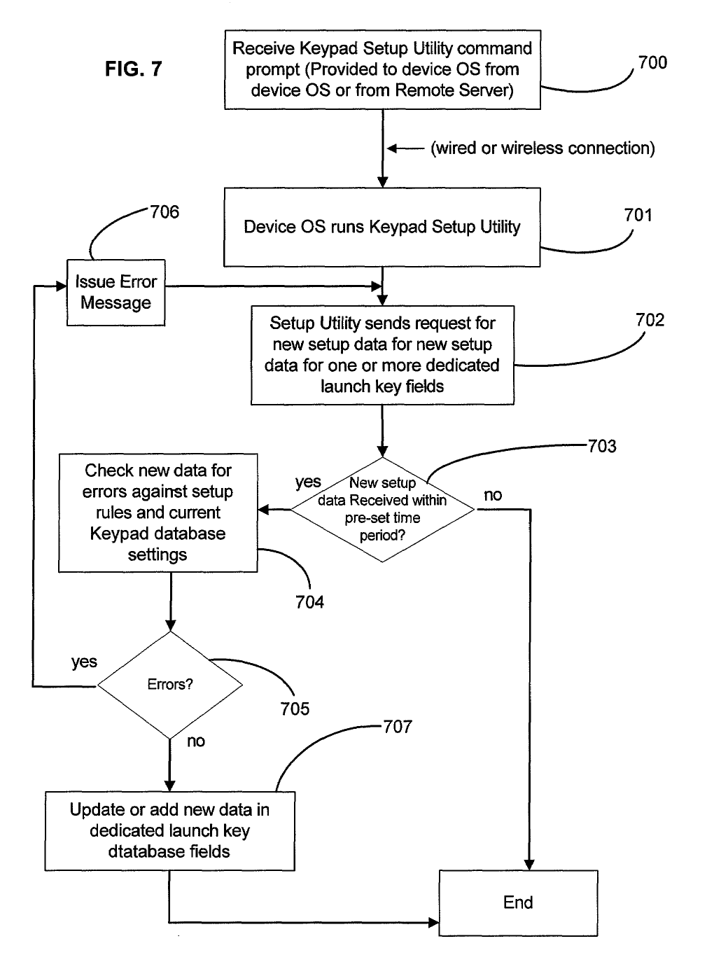

The Definition fields 607 include a set of entries that hold the data and defining characteristics of each key in the dynamic array 31 (depicted herein above with reference to FIG. 3) that includes the scrollable right and left hand keys and each associated set of middle twelve keys. These fields define the characteristics of the right hand column keys, including: a key order number field 608 that contains information specifying the numerical placement order in the scrollable right hand column of the defined direct access key database element defined according to the schema depicted in FIG. 6b; a launch key lock flag 609 that is checked by keypad management software 704 (described herein below with reference to FIG. 7) and 920 (described herein below with reference to FIG. 9) determining whether the defined direct access key definition is permitted to be changed dynamically either by the user or by data updates; information to be displayed when that key is visible in the right hand column (e.g., display type field 610, launch key content field 611 including subfields 612 and 613 for holding text and graphics, which information may also be updated dynamically by the keypad setup software 702 (depicted herein below with reference to FIG. 7); information defining functionality to be launched/initiated by the keypad management software 920 (described herein below with reference to FIG. 9) by a press of the defined direct access key (e.g., launch key type 614, launch key run information 615—including the following subfields: URL IP address 616, Application file name 617, URL aggregation ID and field pointer 618, Application aggregation ID and field pointer 619, Meta key ID and field pointer 620 (which is also information that may be updated by the keypad setup software 702 (described herein below with reference to FIG. 7)); direct access launch key navigation key database fields 621 and 622 with information that defines the set of left hand column keys associated with each right hand key and fields with the information that defines the set of middle twelve keys that are associated with each combination of a single right hand column key and a single left hand column key. By way of example, field 622 includes a pointer to a set of data elements corresponding to the key pad “functionality” exposed when a user selects the particular direct access launch key represented by an instance of the data element summarized in FIG. 6b.

The database fields also include a last updated information field 623 indicating when the particular dedicated launch key definition was last modified.

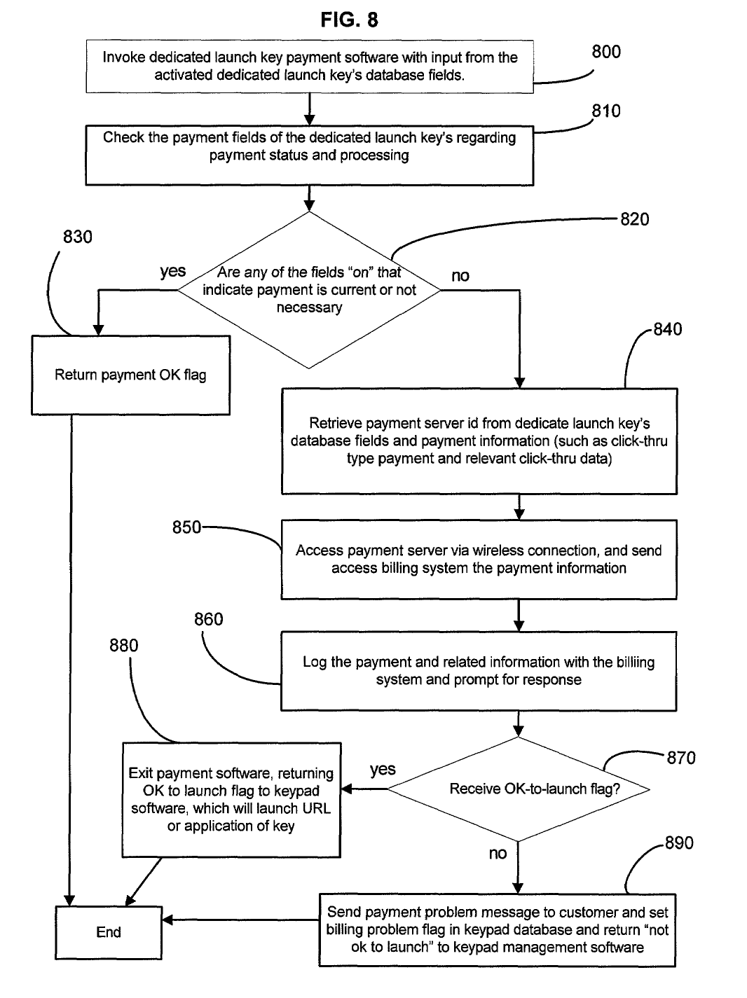

A set of payment information fields 624 including a paid lock/unlock flag 625, a payment type field 626, a billing provider server ID field 627 and a no payment required flag 628. The payment information fields are accessed by the payment software 800 (described herein below with reference to FIG. 8) when a key is selected in order to process any applicable billing and accounting functionality associated with a key press.

The left hand column key fields and the middle twelve key fields, which are defined under a given right hand direct access key, are defined within tables in the database by sets of fields similar to those depicted in FIG. 6b for the right hand column keys.

A set of Navigation (Left Hand) Key definition fields 629 depicted in FIG. 6c includes a (per-right hand key) set of fields and database structures that includes, for instance, a corresponding URL or IP address for a dedicated key that launches a website, and that includes network billing/accounting server information, payment information and related information.

Also depicted, in FIG. 6d, is a keypad 632 of a mobile device indicating the right hand column keys 635 (which may be allocated the role of dedicated launch keys if so specified in the right hand key database fields discussed in FIG. 6b) and the left hand column keys 634 (which, act, when one of these is selected after a selection of a specific right hand column, to define a set of middle twelve keys 633). The middle twelve keys 633 may be allocated the role of dedicated launch keys if so specified in the middle twelve key database fields 636 summarized in FIG. 6e. The roles of the left hand and right hand key columns may be located differently or swapped (right and left, to accommodate left handed users), and may have fewer or more than the four keys depicted in these figures.

The terminology “dedicated launch key” refers to keys in the right hand column 635 and/or keys in the middle twelve key group 633 that have the role allocated to them by fields in the database of directly launching sponsored content, together, as applicable according to the information in the applicable database fields, of displaying the sponsored content branding or other identifier information in the display associated with the applicable key and of activating the accounting/billing sequence when the key is selected.

The roles of the left hand and right hand key columns may be located differently or swapped (right and left, to accommodate left handed users), and may have fewer or more than the four keys depicted in these figures.

In the above described database (set of tables), the information to be displayed and the functionality associated with each key in the scrollable, dynamic keypad array 10 (described herein above with reference to FIG. 1) is established by a combination of the Structural Fields 600 and a set of direct access launch keys defined according to the set of Direct Access Key Definition fields 607 that is accessed and used and updated by the keypad setup software 702 (described herein below with reference to FIG. 7), the payment software 800 (described herein below with reference to FIG. 8) and the keypad management software 920 (described herein below with reference to FIG. 9).

FIG. 7 is an exemplary flow chart summarizing a set of steps for programming and updating the dedicated access and other keys making up the hybrid display/physical key array 10, 31, 40 (described herein above respectively with reference to FIGS. 1, 3 and 4) on a mobile device. During step 700, a keypad setup command prompt is received by the device OS from either the device itself (e.g., the device OS) or from a remote server. In response, during step 701 the device OS invokes a keypad setup utility. Next, during step 702 the setup utility issues a request to a remote server for new direct access key definitions (if any) for the mobile device (e.g., a new field in a current dedicated key, a new dedicated key and associated data or instructions). Thereafter, during step 703, if the setup utility received new data within a pre-set time period in response to the request issued during step 702, then control passes to step 704. In addition, step 703 includes tests to ensure that a mobile device will not repeatedly request a same or repeated erroneous download(s), and, instead, stops requesting the download from the server. If no response is received in a pre-set time period or responses repeatedly contain erroneous data, then control passes from step 703 to the End.

During step 704 the setup utility verifies the new setup against setup rules and/or current keypad database information (e.g., verify that a designated dedicated key is available to be reconfigured to contact a newly specified Web address). Thereafter, at step 705, if errors are detected, then control passes to step 706 wherein an error message is issued by the setup utility and control returns to step 702. Otherwise, if no setup errors are detected (or any detected errors have been corrected), then control passes from step 705 to step 707 wherein the setup utility commits the new launch key configuration to a launch key data structure (e.g., a table, a list, an array, etc.) such as the one depicted herein above with reference to FIGS. 6a and 6b and also re-sets the applicable update fields in the data structure. Control thereafter passes to the End.

FIG. 8 is an exemplary flow chart summarizing a set of steps for auditing dedicated key usage on a sponsorship basis. During step 800, dedicated key payment software is invoked to analyze dedicated launch key ID accounting information (including potentially accessing a variety of accounting information associated with particular launch key IDs) and take any appropriate action based on the analyzed accounting information.

Thereafter, during step 810 a payment software module accesses payment processing information within the launch key information stored, for example, in a launch key data structure (see, e.g., field 624 and associated subfields described herein above with reference to FIG. 6. In an exemplary embodiment where each launch key is associated with a “payments current” flag, during steps 820 and 830 the software ensures that payments are up-to-date for relevant dedicated launch keys (whether in the right hand column or as part of a middle twelve key array associated with an right hand aggregation column key and one of its associated left hand column keys).

During step 820, if payments are current or otherwise flagged as not applicable, then control passes to step 830 wherein an “ok” message is registered. During step 820, if payments are determined to be necessary and are not current, then control passes to steps 840-890 wherein additional steps are performed to attempt to remedy a payment shortfall. During step 840 the payment software operates to read an address for a payment server associated with the dedicated launch key for which payments are not current. Thereafter, during step 850 the payment server (and associated billing system) corresponding to the address obtained during step 840 is accessed via a wireless connection.

Next, during step 860, a payment request is submitted to the payment server and logged on the payment server system. The payment request can be in a variety of forms including actual monetary value or registration of a click-through operation.

Control next passes to step 870. In the illustrative example, if during step 870 it is determined that the device received an “ok to launch message” from the payment server/billing system, then control passes to step 880 and the key payment software returns a payment “ok” message thereby indicating to the keypad management software 960 (described herein below with reference to FIG. 9) to proceed with the functionality assigned to that key in the data structure fields. The returned payment “ok” message indicates to the device operating system that it is ok to run application software or process a URL or Internet address corresponding to the dedicated launch key. Control passes to the End. Otherwise, if an “ok to launch message” was not received by the device from the payment server/billing system, then control passes from step 870 to step 890 wherein an error message is displayed by the device and the dedicated launch key request is not processed (e.g., the Web address associated with the dedicated launch key will not be contacted). Control then passes to the End.

A number of alternatives are available to the above-described exemplary steps including: prompting a user for payment, sending an application or URL owner an error/payment due message, running a free application version or accessing a free alternative Web page/address, logging results in a dedicated key's data structure for later processing, retrying after an appropriate delay, etc.

FIG. 9 is an exemplary flowchart summarizing a set of steps for establishing a connection based on a user's selection of a dedicated, direct access key. During step 900 the device OS cyclically looks for pressing of a dedicated launch key in the dynamic hybrid display/physical key array 31 (depicted herein above with reference to FIG. 3) in either the right hand column or part of a middle set of twelve keys as determined by the applicable fields in the data structure that defines the functionality assigned to the keys in that array. If a dedicated launch key has not been selected then control passes back to step 900. Otherwise, if a dedicated launch key has been selected, then control passes to step 920 wherein the device OS runs software/computer-executable instructions corresponding to an ID associated with the selected dedicated launch key. Step 920, in the case where the set of dedicated launch keys is scrollable, includes taking into consideration the current scroll state of the dedicated keys.

Thereafter, during step 930 the device OS indexes into a table entry corresponding to the selected dedicated launch key within the launch key interface database (described herein above with reference to FIGS. 6a and 6b), using the pressed key and/or scroll state as a guide (to specify a dedicated launch key ID). During step 930 the information in the dedicated launch key database entry associated with the dedicated launch key ID is accessed. During step 940 the payment type information in the database entry is checked and a payment processor is invoked (potentially accessing a remote payment server) according to the exemplary steps described herein above with reference to FIG. 8. During step 950, if the payment processor successfully verifies that payments are current then control passes to step 960 wherein functionality associated with the dedicated launch key is executed. For example, if a URL is associated with the selected direct launch key, then the mobile device's default Web browser is launched and the URL is specified as the initially accessed Web page. If the Web browser is already open, then the Web page is loaded in place of the existing Web page (or alternatively a new tab is opened). If an executable application (such as an application accessed from a networked server) or a Web-based service is associated with the direct access key, then the application program or Web-based service is invoked. Control next returns to step 900.

Otherwise, if a payment error is identified during step 950, then control passes to step 970. During step 970 a payment error management process is invoked. The error management process, by way of example, reports the error to the user and other impacted parties (e.g., the sponsor/payer). Thereafter, control returns to step 900.

In further discussion of step 960, if the dedicated launch key is associated with a URL, then a browser is launched on the mobile device with an initial page address set to the IP address associated with the selected dedicated launch key, or, alternatively, if the browser is already open, then the browser is given the URL to open, in a new tab if tabbed browsing is enabled in the browser. If appropriate, the system supplies the device owner's associated logon credentials, as stored in the database fields, to identify the user to the website at the URL according to the user logon credentials previously specified for the launch key in the launch key data structure for use by the website to launch the user's personal pages, and, as appropriate, to download a customized or personalized set of key settings to the device keypad.

The structures, techniques, and benefits discussed above are merely exemplary embodiments of the invention carried out by software executed on computing machines and stored on computer-readable media in the form of computer executable instructions. In view of the many possible embodiments to which the principles of this invention may be applied, it should be recognized that the embodiments described herein with respect to the drawing figures are meant to be illustrative only and should not be taken as limiting the scope of invention. The illustrated embodiments can be modified in arrangement and detail without departing from the spirit of the invention. Moreover, those of skill in the art will recognize that the disclosed principles are not limited to any particular local area network protocols and/or topologies. Therefore, the invention as described herein contemplates all such embodiments as may come within the scope of the following claims and equivalents thereof.

What is claimed is:

1. A portable wireless device facilitating access to sponsored content over a wireless network, the device comprising:
a keypad user interface comprising:
a set of dedicated launch keys, and
a first set of programmable displays integral to the keypad associated with, but separate from, each one of the set of dedicated launch keys, wherein the displays each present a representation of sponsored content invoked in response to a user pressing a corresponding one of the dedicated launch keys;
a launch key data structure comprising a set of entries corresponding to individual ones of the dedicated launch keys, and wherein each entry includes at least an identification of a networked source of sponsored content accessible by selecting one of the dedicated launch keys; and
a first accounting function that associates selection of one of the dedicated launch keys with a first compensation parameter for the sponsored content associated with the selected dedicated launch key.

2. The device of claim 1 further comprising:
a programmable input key array separate and distinct from the set of dedicated launch keys;
a second set of programmable displays associated with each key of the programmable input key array,
programmable displayed value sets assignable to ones of the programmable input key array and corresponding ones of the set of programmable displays, wherein the programmable displayed value sets are assigned to the programmable input key array in response to selection, by a user, of one of the dedicated launch keys.

3. The device of claim 2 further comprising a second accounting function associated with the programmable input key, and wherein the second accounting function associates a selection of a key of the programmable input key array with a second compensation parameter.

4. The device of claim 2 further comprising a programmable domain selection key array with programmable displays associated with each key of the programmable domain selection key array that is separate and distinct from the dedicated launch key array and the programmable input key array.

5. The device of claim 1 wherein the programmable displays are virtually segmented by display driver software to permanently associate the active viewing area located physically above a mechanical key to dynamically display the function of each mechanical key according the present user selection among the dedicated launch keys, programmable domain keys and input keys according to a scroll state of the system.

6. The device of claim 1 wherein the compensation parameter defines a charge to a content sponsor associated with a particular one of the dedicated launch keys.
